(19) United States
(12) Patent Application Publication
(10) Pub. No.: US 2025/0100378 A1
(43) Pub. Date: Mar. 27, 2025

(54) VEHICLE AND CONTROL METHOD THEREFOR

(71) Applicants: Hyundai Motor Company, Seoul (KR); Kia Corporation, Seoul (KR)

(72) Inventors: Jun Yong LEE, Seongnam-si (KR); Sung Ik JO, Hwaseong-si (KR); Seung Eun YU, Bucheon-si (KR); Sung Jae OH, Hwaseong-si (KR)

(21) Appl. No.: 18/418,706

(22) Filed: Jan. 22, 2024

(30) Foreign Application Priority Data
Sep. 25, 2023 (KR) 10-2023-0128547

(51) Int. Cl. B60K 35/10

(52) U.S. Cl. CPC B60K 35/10; B60K 2360/115; B60K 2360/139; B60K 2360/5899; B60K 2360/731

(57) ABSTRACT

A vehicle and a control method therefor are disclosed. The vehicle control method includes receiving integrated control information including one or more integrated control items with operation conditions set for one or more controllable items of the vehicle, providing an integrated control menu based on the integrated control information, and, when one of the integrated control items is selected from the integrated control menu, controlling each of the controllable items comprised in the selected integrated control item in accordance with the operation conditions corresponding thereto.

### CROSS-REFERENCE TO RELATED APPLICATION

This application claims the benefit of Korean Patent Application No. 10-2023-0128547 filed on Sep. 25, 2023 in the Korean Intellectual Property Office, the disclosure of which is incorporated herein by reference.

### TECHNICAL FIELD

The present disclosure relates to a vehicle and a control method therefor, and more particularly to a vehicle and a control method therefor in which a part or all of controllable items for the vehicle are grouped, and operation conditions for the grouped controllable items are set, thereby facilitating efficient operation of the controllable items within an interior of the vehicle.

### BACKGROUND

In accordance with active research on electrification and electronic control of vehicles, vehicle manufacturers develop and provide various services associated with autonomous driving technology, various drive modes, expansion of an infotainment function, etc. in order to cope with various needs of consumers.

As a vehicle is electrified and electronically controllable, hardware of a large part of the vehicle is controlled through software. A minimum number of physical keys is provided in an interior of the vehicle, and most hardware configurations of the vehicle are controllable through manipulation of a display panel such as an audio/video/navigation (AVN). Furthermore, it may be possible to control the vehicle through a smartphone in association with, for example, remote start, operation of an air conditioner, and parking and leaving of the vehicle.

As such, vehicles gradually have a tendency to be recognized as a device such as a smartphone.

The above matters disclosed in this section are merely for enhancement of understanding of the general background of the disclosure and should not be taken as an acknowledgement or any form of suggestion that the matters form the related art already known to a person skilled in the art.

### SUMMARY

The present disclosure is directed to a vehicle and a control method therefor in which a part or all of controllable items for the vehicle are grouped, and operation conditions for the grouped controllable items are set, thereby enabling the vehicle to easily operate for the controllable items within an interior thereof.

The present disclosure is directed to a control method for a vehicle, the control method including receiving integrated control information including one or more integrated control items with operation conditions set for one or more controllable items of the vehicle, providing an integrated control menu based on the integrated control information, and, when one of the integrated control items is selected from the integrated control menu, controlling each of the controllable items included in the selected integrated control item in accordance with the operation conditions corresponding thereto.

A name of the integrated control item may be determined based on an input by a user.

The control method may further include setting an account of an individual by the vehicle and linking the account with a server and a terminal by the vehicle, before the receiving integrated control information.

The receiving integrated control information may include receiving integrated control information from the account-linked server or the account-linked terminal.

The control method may further include sharing the integrated control item with the account-linked server.

The integrated control item may include a drive mode, steering sensitivity, a user-assist function, a window, a seat, indoor and outdoor light, an air conditioning mode, and an operation time point of the vehicle.

According to another aspect of the present disclosure, a vehicle can include a display device, and a central controller configured to receive, from a terminal or a server, integrated control information including one or more integrated control items with operation conditions set for one or more controllable items of the vehicle, to provide, through the display device, an integrated control menu based on the integrated control information, and, when one of the integrated control items is selected from the integrated control menu, to control each of the controllable items included in the selected integrated control item in accordance with the operation conditions corresponding thereto.

The central controller may provide the integrated control menu through a cluster or an audio/video/navigation (AVN) of the vehicle.

The vehicle may further include a plurality of sub-function controllers configured to control a function of each of the integrated control items. The sub-function controllers may control controllable items transmitted from the central controller, based on operation conditions corresponding to the controllable items, respectively.

The terminal or the server may transmit and receive information in linkage with an account set by the central controller.

The central controller may learn a use pattern of a user for controllable items when the user drives the vehicle, thereby recommending an integrated control item to the user.

The central controller may record a use pattern of a user for controllable items in accordance with a user's request, thereby creating an integrated control item.

In accordance with a user's request, the central controller may share an integrated control item with another user through the server.

### BRIEF DESCRIPTION OF THE DRAWINGS

FIG. 1 is a diagram illustrating an example of a flowchart of a control method for a vehicle.

FIG. 2 is a diagram illustrating an example of a vehicle and a terminal, and a server.

FIG. 3 is a diagram illustrating an example of integrated control items displayed on an audio/video/navigation (AVN) of the vehicle.

FIGS. 4 to 6 are diagrams illustrating an example of setting of operation conditions through the terminal.

FIG. 7 is a diagram illustrating an example of a flowchart of a method for sharing a routine of a user.

### DETAILED DESCRIPTION

The controller referred to as a central controller or a sub-function controller in this specification may include a communication device configured to communicate with another controller or a sensor for control of a function to be performed thereby, a memory configured to store an operating system, logic commands, input/output information, etc., and at least one processor configured to execute discrimination, calculation, determination, etc. required for control of the function to be performed.

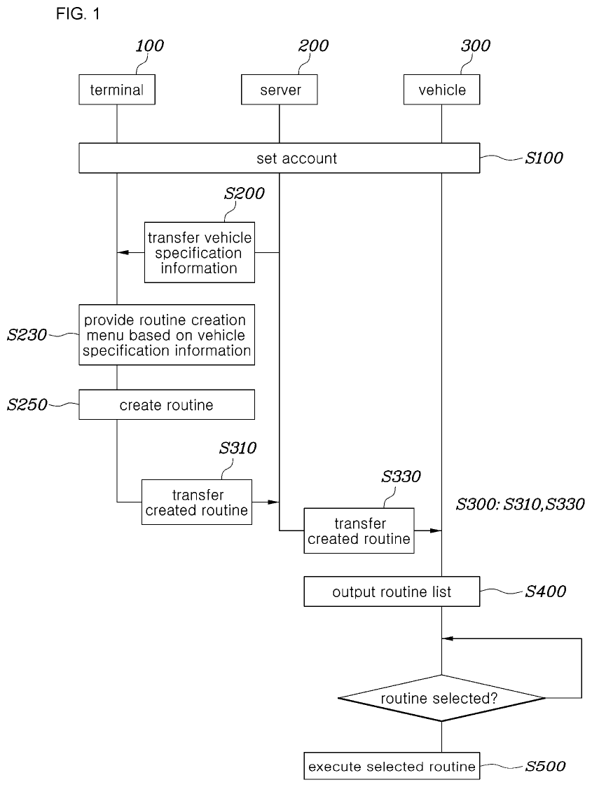

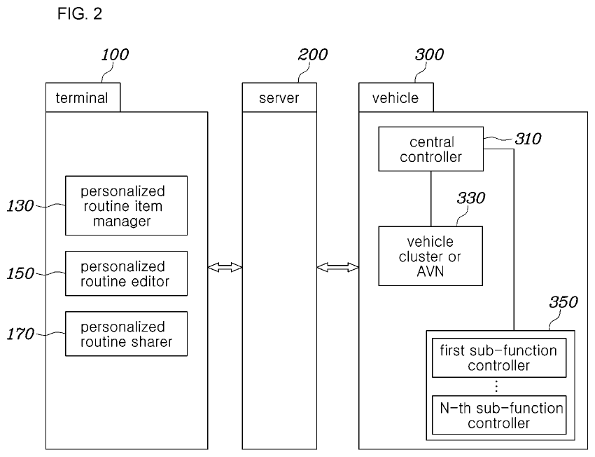

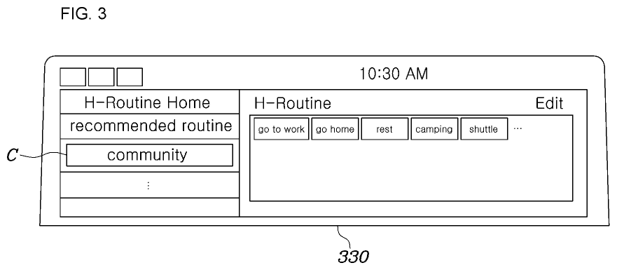

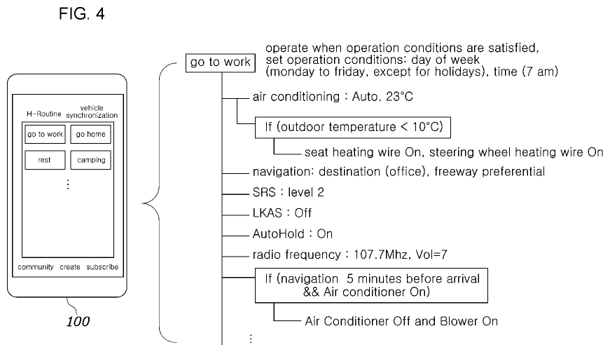

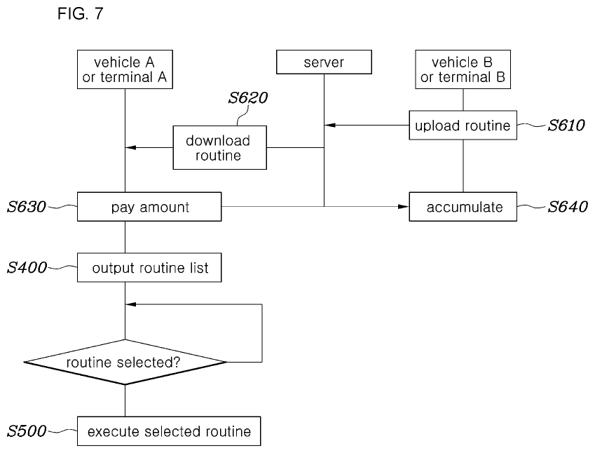

FIG. 1 shows a flowchart of a control method for a vehicle. FIG. 2 shows a configuration diagram of a vehicle and a terminal, and a server. FIG. 3 shows integrated control items displayed on an audio/video/navigation (AVN) of the vehicle. FIGS. 4 to 6 show setting of operation conditions through the terminal. FIG. 7 is a flowchart of a method for sharing a routine of a user.

The vehicle, which is designated by reference numeral “300”, includes a central controller 310 configured to receive, from a terminal 100 or a server 200, integrated control information including one or more integrated control items with operation conditions set for one or more controllable items of the vehicle 300, to provide an integrated control menu based on the integrated control information, and, when one of the integrated control items is selected from the integrated control menu, to control each of the controllable items included in the selected integrated control item in accordance with the operation conditions corresponding thereto.

In this case, the terminal 100 may be a means capable of communicating with the server 200 or the vehicle 300, like a personal smartphone or tablet. The server 200 may communicate with the terminal 100 or the vehicle 300, may receive information transmitted from the terminal 100 or the vehicle 300, may then re-transmit the received information to the terminal 100 or the vehicle 300, and may store the received information therein.

In the present disclosure, the controllable items of the vehicle 300 may refer to all generally-controllable hardware or software configurations of the vehicle 300. For example, the controllable items may include a drive mode of the vehicle (a sports mode, an eco-mode, a terrain mode, etc.), a suspension, steering sensitivity associated with a steering wheel, a user-assist function including maintenance of a safe distance from vehicles ahead, a speed limitation function, an autonomous driving function, etc., window position adjustment, seat position adjustment, brightness of indoor light and outdoor light, an air conditioning mode (cooling, heating, fan speed, and temperature), and operation time points.

Integrated control information may refer to concretely-set operation conditions of controllable items of the vehicle 300. For example, when an indoor temperature is 10° C. or less, integrated control information means operation conditions set to operate a heating wire of a steering wheel or operation conditions set to operate a heating wire of a seat. That is, the operation start time of the heating wire of the steering wheel or the heating wire of the seat corresponds to the case in which the indoor temperature is 10° C. or less.

The integrated control menu provides a list of integrated control items. Each integrated control item may mean a routine of an individual. The individual, who is a user, may specify the name of his daily routine as the name of an integrated control item. That is, it should be noted that, in the specification, routines are used to have the same meaning as integrated control items.

For example, FIG. 3 shows integrated control items displayed on an AVN of a vehicle of one user. The user, who will be illustratively designated, normally goes to work and goes home from work on weekdays. Accordingly, the integrated control items of the user include items “go to work” and “go home”.

FIGS. 4 to 6 show setting of operation conditions through a terminal. Referring to FIG. 4, the designated user may identify that operation conditions have been set in an integrated control item named “go to work” in association with controllable items such as air conditioning temperature, air conditioner turn-off time, seat heating wire and steering wheel heating wire operation conditions, destination setting of a navigation, supplemental restraint system (SRS) level, line keeping assistant system (LKAS), auto-hold, radio frequency, radio volume, etc.

Setting of such operations conditions may be performed through the terminal 100 shown in FIG. 4.

Referring to FIG. 1, the user may create a “go to work” integrated control item (routine) by accessing a personalized routine item manager of the terminal 100. After creation of the routine, the user may add controllable items to the “go to work” routine by accessing a personalized routine editor 150, and may then set operation conditions of the controllable items.

In more detail, the user may set the “go to work” routine to be automatically executed when the engine of the vehicle starts around 7 AM on weekdays from Monday to Friday, except for holidays.

That is, the time when the “go to work” routine is executed is when operation conditions are satisfied, and the operation conditions are satisfied when the engine of the vehicle starts around 7 AM on weekdays from Monday to Friday, except for holidays. The user may change the execution time of the “go to work” routine into “upon engine start”. When the execution time of the “go to work” routine is changed to “upon engine start”, the “go to work” routine is executed in any environment, so long as the engine of the vehicle starts (ON).

In addition, the user may set an indoor air conditioning temperature to 23° C., may set the seat heating wire and the steering wheel heating wire to operate, if an outdoor temperature is 10° C. or less, and may set a destination of the navigation to an address of an office.

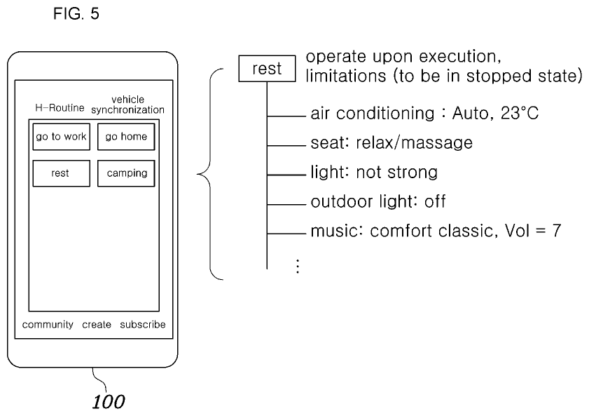

Referring to FIG. 5, the designated user may identify that operation conditions have been set in an integrated control item named “rest” in association with controllable items such as air conditioning temperature, seat position, indoor light, outdoor light, and music. The user may identify that the “rest” routine has been set to be executed only through direct manipulation of the user and to be executed only when the vehicle is in a stopped state.

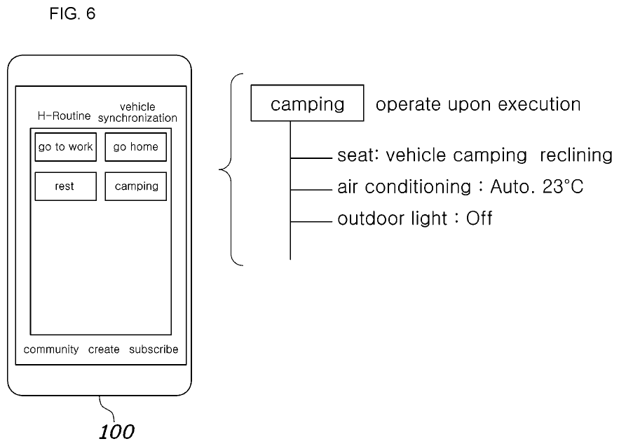

Referring to FIG. 6, the designated user may identify that operation conditions have been set in an integrated control item named “camping” in association with controllable items such as seat position, air conditioning temperature, and outdoor light. The user may identify that the “camping” routine has been set to be executed only through direct manipulation of the user.

Meanwhile, as described above, a group of integrated control items additionally including controllable items is represented as an integrated control menu, as described above. The integrated control menu may be provided by the central controller 310 through a cluster or the AVN 330 of the vehicle, as shown in FIG. 3.

When the user selects going to work, controllable items included in the integrated control item “go to work” operate under predetermined conditions, and the central controller 310 of the vehicle controls the controllable items through a sub-function controller 350, for control for the controllable items. In this case, the sub-function controller 350 may include one or more of a body controller configured to perform control for windows, seats, etc. of the vehicle, a steering controller configured to perform control for a suspension, a steering wheel, etc. of the vehicle, and a powertrain controller configured to control an engine (or a battery and a drive motor), a transmission, etc. of the vehicle. Of course, the sub-function controller 350 is illustrative and, as such, the present disclosure is not limited thereto.

Hereinafter, a control method for the vehicle will be described in detail.

The vehicle control method can include receiving integrated control information including one or more integrated control items with operation conditions set for one or more controllable items of the vehicle (S300), providing an integrated control menu based on the integrated control information (S400), and, when one of the integrated control items is selected from the integrated control menu, controlling each of the controllable items included in the selected integrated control item in accordance with the operation conditions corresponding thereto (S500).

In detail, step S300 of receiving integrated control information means receiving integrated control information including one or more integrated control items with operation conditions set for one or more controllable items of the vehicle 300 transmitted from a server 200 or a terminal 100.

As described above, operation conditions for controllable items are included in integrated control information.

Step S400 of providing an integrated control menu based on the integrated control information is a step of providing, by a central controller 310, an integrated control item (routine) named by the user through a cluster or an AVN 330 of the vehicle. As described above, a personalized routine may be provided through the cluster or the AVN 330 of the vehicle, as shown in FIG. 3.

The user may select one routine from the integrated control menu through the cluster or the AVN 330 of the vehicle. When the user selects one routine, controllable items included in the routine are controlled in accordance with operation conditions corresponding thereto.

In detail, only a method for linking the vehicle 300, the server 200, and the terminal 100 with one another in order to represent the integrated control menu (routine list) in the vehicle will be described in detail because how controllable items included in a selected routine are controlled has been described.

In order to output a routine list by the vehicle 300, setting an account of an individual, who is a user, by the vehicle 300 and linking the account with the server 200 and the terminal 100 by the vehicle 300 (S100) may be executed. Log-in may be executed in the vehicle 300 and the terminal 100 through the account of the user and, as such, the account may be linked in the vehicle 300 and the terminal 100. Accordingly, the routine created by the terminal 100 may be transmitted to the vehicle 300 via the server 200.

After linkage of the account, vehicle specification information is first transmitted from the server 200 to the terminal 100 (S200). Since controllable items provided for different vehicles are different, the server 200 linked with the vehicle 300 identifies information of the vehicle 300, and then transmits, to the terminal 100, vehicle specification information including information as to controllable items provided from the vehicle 300.

When the terminal 100 receives the vehicle specification information, the terminal 100 provides, to the user, providable items, that is, a routine creation menu based on the vehicle specification information (S230). The user may create a routine through a personalized routine item manager 130 of the terminal 100, may add controllable items to the created routine through a personalized routine editor 150, and may set detailed operation conditions for the added controllable items.

Thereafter, the user may transmit integrated control information to the vehicle 300 through the account-linked terminal 100. In this case, the server 200 receives the integrated control information, and then transmits the received integrate control information to the vehicle 300, and, as such, a central controller 310 of the vehicle 300 may receive the integrated control information.

Meanwhile, in accordance with the present disclosure, the user may share a routine customized by himself with another user, or may share a routine customized by another user. Plural users may each prepare an integrated control item (routine) through the terminal 100, and may share the prepared routine with the server 200 account-linked through the central controller 310 of the vehicle 300 or the terminal 100.

FIG. 7 is a flowchart of a method for sharing a routine prepared by a user. The method will be illustratively described with reference to FIGS. 3 and 5. A user B of a vehicle B desires to share his or her routine. In this case, the user B of the vehicle B may access a community C through his or her vehicle B and may then upload his or her routine in the server 200 (S610), or may access a personalized routine sharer 170 of his or her terminal B and may then upload his or her routine to the server 200 (S610).

A user A of a vehicle A may access the community C through his or her vehicle A and may then download the routine of the user B (S620). In this case, the user A may pay a certain amount to the user B in exchange for download of the routine (S630). The certain amount may be an amount predetermined by the user B upon uploading the routine.

Meanwhile, the amount paid by the user A is accumulated to the user B (S640), and the user B may exchange the amount into cash or may use the amount to buy a routine of another user.

Meanwhile, the routine shared by the user A is transferred to a routine list and, as such, when the routine is selected by the user A, the selected routine is executed (S500).

In accordance with the vehicle and the vehicle control method as described above, there are advantages as follows. That is, a part or all of controllable items for the vehicle may be grouped, and operation conditions for the grouped controllable items may be set, thereby enabling the vehicle to easily operate for the controllable items within an interior thereof. In addition, the user may vary operation conditions of the grouped controllable items or may omit or add controllable items, to meet a given situation, if necessary, and, as such, free customization may be achieved. Furthermore, plural users may share programs customized by themselves with one another free of charge or with payment.

Meanwhile, although the user may directly create a routine, the central controller may directly recommend a routine after learning a driving tendency of the user. That is, the central controller may learn a driving tendency of the user based on information as to a driving time of the user, a current date, a current weather, etc.

For example, when the user drives the vehicle in the morning on a weekday, to go to work under the condition that an air conditioning temperature is 23° C., a destination of the navigation is office, an auto-hold function is ON, and a listening music is a classic music, and this pattern is regularly repeated several times, the central controller may recommend learned results to the user.

The user may select the routine recommended by the central controller, and may directly specify a name of the routine.

In addition, the central controller may record a use pattern of the user for controllable items in accordance with a user's request. That is, the user may request the central controller to record his or her use pattern, without directly creating a routine through his or her terminal, and the central controller may then record the use pattern of the user for executed controllable items of the user, and may create the recorded use pattern as one routine.

For example, when the user sets an air conditioning temperature to 18° C., a fan speed to medium, a radio frequency to 107.7 MHz, a radio volume to 7, an auto-hold function to ON, and a drive mode to an eco-mode, after requesting the central controller to create a routine, the central controller may record the controllable items, and may then create one routine using the recorded controllable items.

As apparent from the above description, in accordance with the vehicle and the vehicle control method as described above, there are advantages as follows. That is, a part or all of controllable items for the vehicle may be grouped, and operation conditions for the grouped controllable items may be set, thereby enabling the vehicle to easily operate for the controllable items within an interior thereof. In addition, the user may vary operation conditions of the grouped controllable items or may omit or add controllable items, to meet a given situation, if necessary, and, as such, free customization may be achieved. Furthermore, plural users may share programs customized by themselves with one another free of charge or with payment.

What is claimed is:

1. A control method for a vehicle comprising:
receiving integrated control information comprising one or more integrated control items, each item being associated with one or more controllable items of the vehicle, and one or more operation conditions of the vehicle being set for each of the one or more controllable items;
providing an integrated control menu based on the integrated control information; and
controlling, based on one of the one or more integrated control items being selected from the integrated control menu, each of the one or more controllable items associated with the selected integrated control item according to the one or more operation conditions set to each of the one or more controllable items.

2. The control method according to claim 1, wherein a name of each of the one or more integrated control items is determined based on received information.

3. The control method according to claim 1, further comprising:
setting, by the vehicle, an account of an individual and linking, by the vehicle, the account with a server and a terminal, before the integrated control information is received.

4. The control method according to claim 3, wherein receiving the integrated control information comprises receiving the integrated control information from the server or the terminal.

5. The control method according to claim 3, further comprising:
sharing the one or more integrated control items with the server.

6. The control method according to claim 1, wherein the one or more integrated control items comprise a drive mode, steering sensitivity, a user-assist function, a window, a seat, indoor and outdoor light, an air conditioning mode, and an operation time point of the vehicle.

7. A vehicle comprising:
a display device; and
a central controller configured to perform operations comprising:
receiving, from a terminal or a server, integrated control information comprising one or more integrated control items, each item being associated with one or more controllable items of the vehicle, and one or more operation conditions of the vehicle being set for each of the one or more controllable items,
providing, through the display device, an integrated control menu based on the integrated control information, and
controlling, based on one of the one or more integrated control items being selected from the integrated control menu, each of the one or more controllable items associated with the selected integrated control item according to the one or more operation conditions set to each of the one or more controllable items.

8. The vehicle according to claim 7, wherein the central controller is configured provide the integrated control menu through a cluster or an audio/video/navigation (AVN) of the vehicle.

9. The vehicle according to claim 7, further comprising:
a plurality of sub-function controllers configured to control operations of each of the one or more integrated control items,
wherein the plurality of sub-function controllers are configured to control one or more controllable items transmitted from the central controller, based on one or more operation conditions set to the controllable items, respectively.

10. The vehicle according to claim 7, wherein the terminal or the server is configured to transmit and receive information in linkage with an account set by the central controller.

11. The vehicle according to claim 7, wherein a name of each of the one or more integrated control items is determined based on received information.

12. The vehicle according to claim 7, wherein the one or more integrated control items comprise a drive mode, steering sensitivity, a user-assist function, a window, a seat, indoor and outdoor light, an air conditioning mode, and an operation time point of the vehicle.

13. The vehicle according to claim 7, wherein the central controller is configured to learn a use pattern of controllable items based on the vehicle being operated, thereby recommending an integrated control item through the display device.

14. The vehicle according to claim 7, wherein the central controller is configured to store a use pattern of controllable items based on a received input, thereby creating an integrated control item.

15. The vehicle according to claim 7, wherein the central controller is configured to, based on a received input, share an integrated control item an account associated with the vehicle through the server.
